(19) United States
(12) Patent Application Publication
(10) Pub. No.: US 2008/0162957 A1
(43) Pub. Date: Jul. 3, 2008

(54) Selectively powering data interfaces

(76) Inventors: Paul Lassa, Cupertino, CA (US); Paul Paternoster, Los Altos, CA (US); Po-Shen Lai, San Jose, CA (US); Yongliang Wang, Saratoga, CA (US)

Correspondence Address: ROBERT J. STERN, 3074 HARCROSS RD., WOODSIDE, CA, 94062, US

(21) Appl. No.: 11/649,325

(22) Filed: Dec. 31, 2006

(51) Int. Cl. G06F 1/28

(52) U.S. Cl. 713/310

(57) ABSTRACT

A plurality of separately powered data interface circuits, a controller circuit, and power switch circuits that collectively enable a supply of power to only one of the data interface circuits and disable the supply of power to the other data interface circuits.

### FIELD OF THE INVENTION

The invention relates generally to electrical devices having a plurality of separately powered data interface circuits. More specifically, the invention relates to reducing power consumption of such devices by disabling the supply of power to all but one of the data interface circuits.

### BACKGROUND OF THE INVENTION

Electrical devices commonly include one or more data interface circuits for communicating with other electrical devices. For example, data interface circuits commonly implement the data communications protocols required by one of the industry-standard interfaces such as USB (Universal Serial Bus), MS (Memory Stick), SD (Secure Digital), MMC (Multi-Media Card), and CF (Compact Flash). These illustrative industry-standard data interfaces are commonly used by computers, digital cameras, digital music players, mobile telephones and video games.

Most of the industry-standard data interfaces require a physical connector (port) that is incompatible with other industry-standard interfaces. To achieve physical compactness, portable devices such as portable non-volatile memory sticks typically include only one or two physical connectors for an equal number of corresponding data interfaces. Therefore, if a manufacturer of such portable devices wants to offer products compatible with different industry-standard data interfaces, the manufacturer typically offers a different model of portable device for each type of data interface.

### SUMMARY OF THE INVENTION

The invention enables an electrical apparatus to include a plurality of data interface circuits and ports without consuming more power than an apparatus that includes only a single data interface circuit.

A first aspect of the invention is an apparatus having a plurality of separately powered host interface circuits that are adapted to receive electrical power from, and transfer data to or from, a host electrical device external to the apparatus. The apparatus further includes a controller circuit and power switch circuits that collectively enable a supply of power from the host device to only one of the host interface circuits and disable the supply of power to the other host interface circuits. The invention advantageously reduces power consumption by disabling power to all but one host interface circuit.

Even if the apparatus does not include an external electrical connector for one or more of the host interface circuits, the invention is advantageous because it permits a single integrated circuit to include a plurality of host interface circuits without consuming any more power than if it included only a single host interface circuit. Such an integrated circuit can be mounted in different packages that are connected to different ones of the host interface circuits. Accordingly, a single integrated circuit design can be incorporated in a variety of products, advantageously achieving greater economy of scale and avoiding the need to design and inventory multiple integrated circuits for use in multiple products.

An additional advantage of the invention is that including multiple host interfaces on one integrated circuit increases the probability that at least one of the host interfaces will not suffer a defect during manufacturing. If one host interface is defective but another host interface is good, the integrated circuit can be packaged in a product designed to use only the good interface, thereby avoiding the need to discard the partially defective integrated circuit and hence increasing manufacturing yield.

Preferably the controller circuit selects which one host interface circuit to enable in response to the apparatus receiving power from the external host device, which signifies that the apparatus has been connected to the external host device. Preferably the controller circuit does not enable power to any other host interface circuit so long as the apparatus continues to receive power from the external host device.

A broader aspect of the invention is an apparatus having a plurality of separately powered data interface circuits. Unlike the first aspect of the invention, the apparatus need not receive electrical power from an external host device. The apparatus further includes a controller circuit and power switch circuits that collectively enable a supply of power to only one of the data interface circuits and disable the supply of power to the other data interface circuits. The invention advantageously reduces power consumption by disabling power to all but one data interface circuit. Preferably the apparatus is a portable or battery-powered device for which low power consumption is highly desirable.

In a yet broader aspect of the invention, the separately powered circuits need not be data interface circuits, but can be any separately powered electrical circuits that are not used concurrently. The invention advantageously reduces power consumption by disabling power to all but one of the separately powered circuits.

The invention further includes method counterparts of each of the apparatus aspects summarized above.

### BRIEF DESCRIPTION OF THE DRAWINGS

FIG. 1 is a block diagram of a preferred embodiment of the invention.

### DETAILED DESCRIPTION OF THE PREFERRED EMBODIMENTS

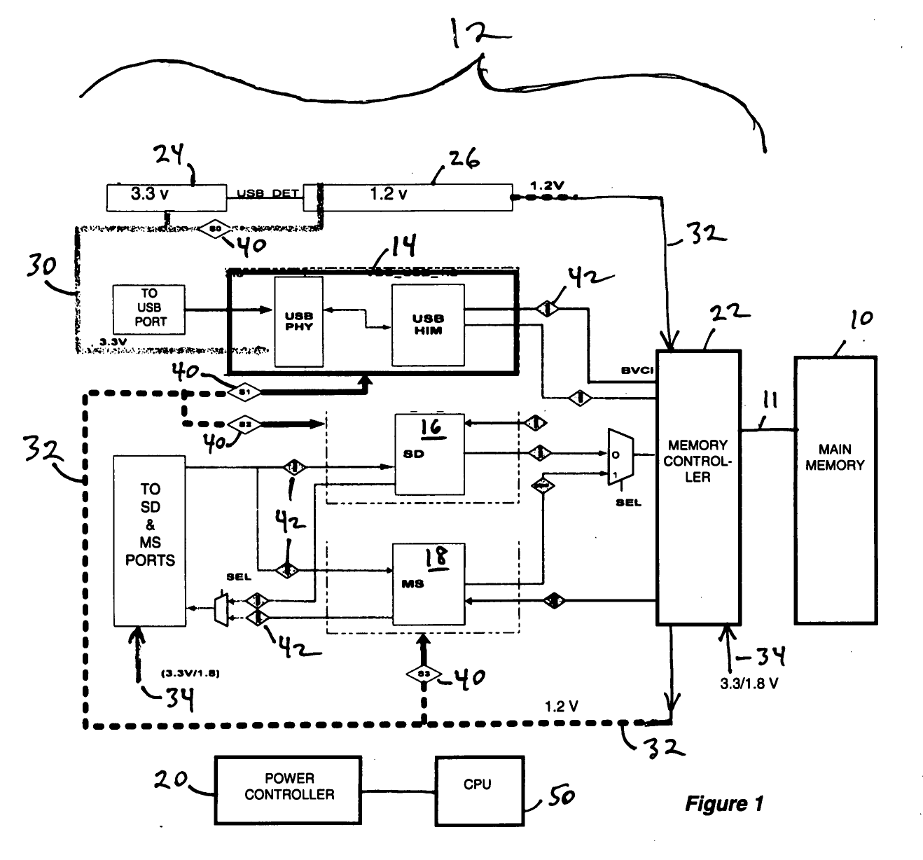

FIG. 1 is a block diagram of a preferred embodiment of the apparatus of the invention, which is a portable non-volatile memory stick having three different host interface circuits for transferring data with a host device that is external to the memory stick apparatus. By “transferring data with a host device” we mean sending data to the host, receiving data from the host, or both. Examples of a host device to which such a portable memory stick could be connected are a computer, a digital camera, a portable music player, a mobile telephone, or a video game console.

The memory stick includes two integrated circuits: a main memory (non-volatile flash memory) integrated circuit 10, and a combination interface and combination integrated circuit 12. The two integrated circuits are connected by conductors 11, such as conductors on a printed wiring board on which the integrated circuits may be mounted. The combination integrated circuit 12 in the exemplary embodiment includes three host interface circuits 14, 16, 18, a power controller circuit 20, a memory controller circuit 22, a 3.3 volt voltage regulator 24, and a 1.2 volt voltage regulator 26.

For purposes of this patent specification, we use the term “port” to mean a physical connector through with data can be transferred in accordance with an interface communications protocol. Different interface standards generally require different ports and different communications protocols. Each port is associated with one corresponding host interface circuit that transfers data through the port in compliance with the interface communications protocol for that type of port.

In the exemplary memory stick, the three host interface circuits are a USB host interface circuit 14, an SD host interface circuit 16, and an MS host interface circuit 18. Although all three host interface circuits are included in the combination integrated circuit 12, the memory stick typically has ports for only one or two of the three interface types (USB, SD and MS). The memory stick is capable of connecting only to the types of host interfaces for which it has ports.

The memory stick receives either 5 volt, 3.3 volt, or 1.8 volt power from the host device according to the industry standard specifications for USB, SD and MS interfaces. The combination integrated circuit 16 includes a 3.3 volt bus 30, a 1.2 volt bus 32, and a 1.8/3.3 volt bus 34. The USB host interface 14 receives power from both the 3.3 volt bus 30 and the 1.2 volt bus 32. The other host interfaces 16, 18 and the power controller 20 receive power from the 1.2 volt bus 32. The memory controller 22 receives power from all three buses 30, 32, 34 for compatibility with main memory integrated circuits 10 that use any of these power supply voltages, i.e., 3.3 volt, 1.8 volt, or 1.2 volt.

If the memory stick includes a USB port (not shown), the 5 volt power pin on the USB port is connected to the power input of the 3.3 volt voltage regulator 24. When the memory stick is connected to a USB host, the 3.3 volt voltage regulator 24 receives 5 volt power from the USB host and outputs 3.3 volts to the 3.3 volt bus 30 and the 1.8/3.3 volt bus 34. An input of the 1.2 volt voltage regulator 26 is connected to the 3.3 volt bus 30. The voltage regulator 26 outputs 1.2 volts to the 1.2 volt bus 32.

If the memory stick includes an SD port, an MS port, or both, the power pins of the SD and MS ports are connected to the power input of the 1.2 volt voltage regulator 26. When the memory stick is connected to an SD or MS host, the 1.2 volt voltage regulator 26 receives 3.3 volt or 1.8 volt power from the SD or MS host and couples this power to the 3.3/1.8 volt bus 34. The 1.2 volt voltage regulator also outputs 1.2 volts to the 1.2 volt bus 32.

In summary, power may be supplied from a host device to one or more buses within the memory stick by direct connection or through a voltage regulator or other intervening circuit. Within this patent specification, we use the term “power source” to include a direct connection from a port to an interface circuit or a connection through a voltage regulator or other intervening circuit.

In an integrated circuit, a power island (also conventionally called a power domain) is a section of the integrated circuit to which the supply power can be selectively enabled or disabled independently of other power islands on the integrated circuit. Conventional power islands are disclosed in the following US patents and patent applications, the entire content of which is hereby incorporated by reference into this patent specification: U.S. Pat. No. 7,051,306 issued May 23, 2006 to Hoberman, U.S. Pat. No. 7,080,341 issued Jul. 18, 2006 to Eisenstadt, US patent application publication 20010010476 by Weng published Aug. 2, 2001, US patent application publication 20030204757 by Flynn published Oct. 30, 2003, US patent application publication 20040158750A1 by Syed published Aug. 12, 2004, US patent application publication 20050253462 by Falkowski published Nov. 17, 2005, and US patent application publication 20060076977A1 by Zhu published Apr. 13, 2006.

A feature of the preferred embodiment of the invention is that each of the three host interface circuits 14, 16, 18 is fabricated in a distinct power island on the integrated circuit 12. The power controller circuit 20 and the other circuitry of the memory stick apparatus, including memory controller circuit 22, are fabricated in one or more power islands distinct from the power islands of the three host interface circuits. This means the supply of power from the power buses 30, 32, 34 to each the three host interface circuits can be selectively enabled or disabled independently of the other host interface circuits and independently of the other circuitry 22 on the integrated circuit 12. However, the power controller circuit 20 should never be disabled from receiving power, except possibly in testing during manufacture of the integrated circuit 12.

Power controller 20 controls which of the power islands receive power from the power buses by controlling a plurality of power switch circuits 36. Specifically, a power switch circuit 40 is interposed between each host interface circuit and the one or more power buses from which the host interface circuit receives power. Each power switch circuit is connected to supply power to only one of the host interface circuits, so that the supply of power can be enabled and disabled to each host interface circuit independently of the other host interface circuits and independently of the other circuitry 22 of the integrated circuit 12. If a host interface circuit receives power from two or more power buses, a distinct power switch circuit is interposed between that host interface circuit and each of the power buses from which it receives power.

As stated above, the circuitry of the integrated circuit 12 outside the host interface circuits optionally may be fabricated in an additional plurality of power islands, in which case these power islands would be controlled by additional power switch circuits. The additional power switch circuits can be distinguished from those connected to the host interface circuits by referring to the latter as host interface power switch circuits.

Each host interface power switch circuit 40 has a power input, a power output, and a power control input. The power input is connected to one of the power buses to receive power from the power source that supplies power to that bus. The power output is connected to supply power to exactly one of the host interface circuits.

The power control input of each host interface power switch is connected to receive from the power controller 20 a power control signal that can have an enable value or a disable value. The power switch circuit either connects or disconnects the flow of power from its power input to its power output depending on whether the power control input has the enable value or the disable value, respectively. Preferably the enable and disable values are binary logic values so that one value is a logical zero and the other is a logical one.

A valuable feature of the invention is that, during normal operation of the memory stick, the power controller 20 selects exactly one of the host interface circuits to receive power and disables power to the other host interface circuits. We refer to the selected host interface circuit as the “activated” host interface circuit. Specifically, the power controller sends a power control signal having the enable value to each of the host interface power switches 40 connected to the activated host interface circuit, and it sends a power control signal having the disable value to each of the other host interface power switches 40.

Disabling power to the host interface circuits other than the one activated host interface circuit is advantageous to reduce power consumption by the memory stick. This is important because host devices generally can supply only a limited amount of power to peripheral devices connected to their interface ports. Reducing power consumption also is important to devices other than memory sticks, such as battery-powered portable devices that should minimize power consumption to maximize battery life.

In a preferred aspect of the invention, the power controller 20 activates exactly one of the host interface circuits shortly after the memory stick initially is connected to a host device and receives power from the host device. If the memory stick has multiple ports, the power controller can detect which port is connected to a host device by detecting which port is receiving power.

As soon as the memory stick receives power from a host device after a period of not receiving power, the power controller initiates a hardware Power-On Reset (POR) process. The hardware POR process preferably is performed by a hardware logic state machine within the power controller. The power controller detects which memory stick port is receiving power and then establishes that the host interface circuit associated with that port should be activated. The power controller stores a value in a logic circuit within the power controller, referred to herein as the Interface ID logic circuit, that identifies which host interface circuit is activated.

The Interface ID logic circuit can be a state machine including one or more flip-flops, where the respective states of the flip-flops collectively represent which host interface circuit is activated. More preferably, the Interface ID logic circuit is a register in which the power controller stores said value. The integrated circuit preferably includes a programmable processor (CPU) 50 that can read the value stored in the register to determine which host interface circuit is activated and then perform different software or firmware programs as a function of which host interface circuit is activated. (For the purpose of this patent specification, the terms software and firmware are considered equivalent and are used interchangeably.)

Because the identification of which host interface circuit is activated by the power controller can determine the state of a hardware state machine within the power controller or the state of a software state machine within the software executed by the programmable processor, the power controller is considered to be operating in a specific state, referred to as a host interface activation state, after the power controller selects one of the host interface circuits. The power controller is characterized by a distinct host interface activation state associated with each host interface circuit.

After the power controller stores a value in the Interface ID logic circuit that identifies which host interface circuit is activated, the power controller preferably continues the hardware Power-On Reset process by enabling power to the activated host interface circuit and disabling power to the other host interface circuits. As described above, this is accomplished by the power controller sending power control signals to the power switch circuits 40.

After the power controller completes its hardware Power-On Reset process sequence, it preferably commands the programmable processor 50 to begin executing a software Power-On Reset process sequence. The command can be, for example, in the form of the power controller setting a flag in the Interface ID logic circuit or sending a separate Power-On Reset electrical control signal to the programmable processor. As stated above, the software in the programmable processor preferably reads the value stored in the Interface ID logic circuit to determine which host interface activation state has been established by the power controller. The software preferably performs different functions depending on which host interface is activated. The software Power-On Reset sequence preferably is initiated by software stored in a read-only memory, referred to as the Boot ROM, that is connected to the programmable processor.

In a preferred aspect of the invention, after the power controller enters a host interface activation state as just described, for as long as the memory stick continues to receive power from the host device, the power controller does not change which host interface circuit is activated and powered, and the power controller continues to disable power to the other host interface circuits. This continuous disabling of the other host interface circuits has the advantage of minimizing power consumption by the memory stick. In contrast, conventional implementations of power islands in integrated circuits generally reduce or disable power to selected power islands only temporarily, depending on the current activity being performed by the integrated circuit.

The reason it is feasible for the power controller to not change which host interface circuit is activated so long as the memory stick continues to receive power is that a memory stick, even if it has multiple ports, typically is capable of connecting only one port at a time to a host device. To connect a different port of the memory stick to a host device, the memory stick would have to be physically removed from the port on the host device and then physically reinserted to a different port. Removing the memory stick from the port on the host device interrupts the power being provided by the host device to the memory stick. The power controller can operate on the assumption that the port through which the memory stick initially receives power, as described above, is the only port through which the memory stick can communicate as long as that port remains connected to a host device, that is, as long as the memory stick continues without interruption to receive power through that port.

When power is interrupted through the active port, all circuits in the memory stick lose power. When power subsequently is received through one of the ports, the power controller repeats the Power-On Reset sequence described above by identifying which port is receiving power and then activating the host interface circuit associated with that port.

Because the memory stick typically cannot be connected to a different host through a different port without first interrupting power, preferably it should not be possible to modify the value stored in the Interface ID logic circuit after it is initially established by the power controller during the Power-On Reset process. For example, if the Interface ID logic circuit includes a register from which the programmable processor can read such value, the programmable processor should not be permitted to modify such value in the register. An exception is described near the end of this patent specification in the discussion of alternative embodiments.

Each clock input, data input, and data output of each host interface circuit that is connected to circuits outside the power island of the host interface circuit preferably is connected through an isolator circuit 42, as shown in FIG. 1. Each isolator circuit is a gate or latch controlled by a control signal received from the power controller. Conventional isolators connected to power islands are disclosed in the US patents and patent applications identified above as disclosing conventional power islands.

When the power to a given host interface circuit is activated by the power controller, the power controller additionally sends an enable control signal to each isolator circuit connected to that host interface circuit, which causes each isolator circuit to close the connection between its input and output.

Conversely, when the power to a given host interface circuit is disabled by the power controller, the power controller additionally sends a disable control signal to each isolator circuit connected to that host interface circuit. The isolators connected to the clock inputs and data inputs of the host interface circuit, referred to as input isolators, preferably are configured to output a zero voltage signal to the host interface circuit in response to the disable control signal, thereby minimizing any power consumption on account of signals at such inputs. Each input isolator can be implemented as a NOR gate. The isolators connected to the data outputs of the host interface circuit preferably are configured to respond to the disable control signal by either latching the last value before arrival of the disable control signal or by outputting a logic 0 or 1, whichever will avoid any adverse affects on the logic of the other circuit receiving the data output.

Although a memory stick has been described as an example of the invention, the preceding description of the invention also applies to any electrical apparatus that has a plurality of separately powered interface circuits and that receives electrical power from, and transfers data with, a host electrical device external to the apparatus.

Furthermore, the invention also applies to any electrical apparatus that has a plurality of separately powered interface circuits even if the apparatus has its own power supply rather than receiving power from an external host. In that case, instead of detecting which port receives power, the power controller could be configured to select one of the interface activation states based on a value stored in the Interface Logic ID circuit. If the Interface Logic ID circuit includes a register that is accessible by a programmable processor 50, the software executed by the programmable processor could be permitted to modify the values stored in the register, in contrast with the previously discussed embodiments in which the processor was permitted only to read the register values.

A further alternative embodiment of the invention is an electrical apparatus that has only one port, but that includes a plurality of separately powered interface circuits. An example of such apparatus would be memory stick including a combination integrated circuit 12 with separately powered USB, SD and MS interface circuits as described above. A vendor could install the same integrated circuit in three different memory stick products: a first product that only has a USB port, a second product that only has an SD port, and a third product that only has an MS port. The vendor could benefit from economies of scale and reduction of inventory logistics risks by manufacturing a single combination integrated circuit 12 for all three products instead of manufacturing three different integrated circuits with the three respective host interface circuits.

For such an apparatus that has only one port, the Interface Logic ID circuit can be permanently programmed with the identification of which interface circuit is to be activated by the controller circuit. For example, the value stored in the Interface Logic ID circuit could be established by creating a pattern of open or closed circuits within the Logic ID circuit during the manufacture of the apparatus.

The previous description states that power should not be enabled simultaneously for more than one interface circuit. That is true for normal use of the apparatus. However, for testing the apparatus during manufacture, the power controller circuit may be capable of entering additional states of operation such as a diagnostic state in which all interface circuits are on and an off state in which all interface circuits are off. Preferably, entering such additional states should require access to pads within the integrated circuit 12 that are not accessible to the user after the integrated circuit has been mounted in the package sold to consumers.

Various preferred embodiments and implementation features are further discussed in the following U.S. patent applications, each of which has an effective filing date simultaneous with that of the present patent application, and each of which is hereby incorporated by reference in its entirety into the present patent specification:

Ser. No. 11/______ filed 31 Dec. 2006 (attorney docket SDA-1089x), entitled “Decoupling with Two Types of Capacitors”;

Ser. No. 11/______ filed 31 Dec. 2006 (attorney docket SDA-1089y), entitled “Chip with Two Types of Decoupling Capacitors”;

Ser. No. 11/______ filed 31 Dec. 2006 (attorney docket SDA-1090x), entitled “Internally Protecting Lines at Power Island Boundaries”;

Ser. No. 11/______ filed 31 Dec. 2006 (attorney docket SDA-1090y), entitled “Integrated Circuit with Protected Internal Isolation”;

Ser. No. 11/______ filed 31 Dec. 2006 (attorney docket SDA-1091x), entitled “Updating Delay Trim Values”;

Ser. No. 11/______ filed 31 Dec. 2006 (attorney docket SDA-1091y), entitled “Module with Delay Trim Value Updates on Power-Up”;

Ser. No. 11/______ filed 31 Dec. 2006 (attorney docket SDA-1092x), entitled “Limiting Power Island Inrush Current”;

Ser. No. 11/______ filed 31 Dec. 2006 (attorney docket SDA-1092y), entitled “Systems and Integrated Circuits with Inrush-Limited Power Islands”;

Ser. No. 11/______ filed 31 Dec. 2006 (attorney docket SDA-1093x), entitled “Programmably and Locally Detecting Power Valid”;

Ser. No. 11/______ filed 31 Dec. 2006 (attorney docket SDA-1093y), entitled “Systems and Circuits with Programmable and Localized Power-Valid Detection”;

Ser. No. 11/______ filed 31 Dec. 2006 (attorney docket SDA-1094x), entitled “Method for Performing Full Transfer Automation in a USB Controller”;

Ser. No. 11/______ filed 31 Dec. 2006 (attorney docket SDA-1094y), entitled “USB Controller with Full Transfer Automation”;

Ser. No. 11/______ filed 31 Dec. 2006 (attorney docket SDA-1095x), entitled “Method for Configuring a USB Physical Layer Interface to Loopback Mode”; and

Ser. No. 11/______ filed 31 Dec. 2006 (attorney docket SDA-1095y), entitled “Apparatus for Configuring a USB Physical Layer Interface to Loopback Mode”.

1. A method of receiving electrical power from, and transferring data with, a host electrical device external to an apparatus, comprising the steps of:
one or more power sources receiving electrical power from a host electrical device external to the apparatus;
providing a number of host interface circuits, wherein the number is at least two;
providing a controller circuit characterized by a plurality of states of operation that include a plurality of host interface activation states, wherein each respective host interface activation state corresponds to a distinct respective one of the host interface circuits, and wherein the host interface activation states are mutually exclusive so that the controller circuit cannot simultaneously operate in more than one host interface activation state; and
providing a number of host interface power switch circuits, wherein the number of host interface power switch circuits is greater than or equal to the number of host interface circuits, and wherein each respective host interface power switch circuit includes:
(i) a respective power input connected to one of the power sources,
(ii) a respective power output connected to exactly one of the host interface circuits, and
(iii) a respective power control input connected to receive a respective power control signal from the controller circuit;
each host interface power switch circuit selectively enabling or disabling a supply of electrical power from its power input to its power output in response to whether the power control signal received at its power control input has an enable value or a disable value; and
the controller circuit, when operating in each respective host interface activation state, sending a power control signal having said enable value to the power control input of each host interface power switch circuit whose power output is connected to the host interface circuit corresponding to said host interface activation state and sending a power control signal having said disable value to the power control input of each of the other power switch circuits.

2. The method of claim 1, wherein:
after the controller circuit begins operating in one of said host interface activation states, the controller circuit does not subsequently operate in a different host interface activation state while the apparatus receives electrical power from said host electrical device without interruption.

3. The method of claim 1, wherein the controller circuit enters one of said host interface activation states in response to the apparatus receiving power from a host electrical device external to the apparatus and does not subsequently enter a different host interface activation state while the apparatus continues to receive power from said host electrical device.

4. A method of separately powering a plurality of data interface circuits, comprising:
providing one or more power sources;
providing a number of data interface circuits, wherein the number is at least two;
providing a controller circuit characterized by a plurality of states of operation that include a plurality of interface activation states, wherein each respective interface activation state corresponds to a distinct respective one of the data interface circuits, and wherein the interface activation states are mutually exclusive so that the controller circuit cannot simultaneously operate in more than one interface activation state; and
providing a number of power switch circuits, wherein the number of power switch circuits is greater than or equal to the number of data interface circuits, and wherein each respective power switch circuit includes:
(i) a respective power input connected to one of the power sources,
(ii) a respective power output connected to exactly one of the data interface circuits, and
(iii) a respective power control input connected to receive a respective power control signal from the controller circuit;
each power switch circuit selectively enabling or disabling a supply of electrical power from its power input to its power output in response to whether the power control signal received at its power control input has an enable value or a disable value; and
the controller circuit, when operating in each respective interface activation state, sending a power control signal having said enable value to the power control input of each power switch circuit whose power output is connected to the data interface circuit corresponding to said interface activation state and sending a power control signal having said disable value to the power control input of each of the other power switch circuits.

5. The method of claim 4, wherein:said one or more power sources are adapted to receive electrical power from a host electrical device external to the apparatus; and
after the controller circuit begins operating in one of said interface activation states, the controller circuit does not subsequently operate in a different interface activation state while the apparatus receives electrical power from said host electrical device without interruption.

6. The method of claim 4, wherein:
said one or more power sources are adapted to receive electrical power from a host electrical device external to the apparatus; and
the controller circuit enters one of said interface activation states in response to the apparatus receiving power from a host electrical device external to the apparatus and does not subsequently enter a different interface activation state while the apparatus continues to receive power from said host electrical device.

7. The method of claim 4, further comprising:
connecting an electrical port to a power output of a host electrical device external to the apparatus;
wherein one of the power sources includes an electrical conductor connected between the electrical port and the power input of one of the data interface circuits.

8. The method of claim 4, further comprising:
connecting an electrical port to a power output of a host electrical device external to the apparatus;
wherein one of the power sources includes a voltage regulator connected between the electrical port and the power input of one of the data interface circuits.

9. The method of claim 4, further comprising the step of providing an integrated circuit that includes each of the data interface circuits.

10. The method of claim 4, further comprising the step of providing an integrated circuit that includes each of the data interface circuits and the controller circuit.

11. The method of claim 4, wherein each respective data interface circuit is adapted to transfer data in accordance with a respective distinct data communications protocol.

12. The method of claim 4, wherein each respective data interface circuit is adapted to transfer data through a respective distinct interface port.

13. The method of claim 4, further comprising the steps of:
providing in a first one of the data interface circuits an input connected to receive a first electrical signal from a first electrical circuit;
providing a first isolator circuit having a signal input connected to the first electrical circuit, a signal output connected to the input of first data interface circuit, and a control input connected to receive from the controller circuit an isolator control signal having either an enable value or a disable value;
the controller circuit setting the isolator control signal to the enable value when the controller circuit operates in a first interface activation state that corresponds to the first data interface circuit and setting the isolator control signal to the disable value when the controller circuit operates in a interface activation state other than the first interface activation state;
the first isolator circuit, in response to the isolator control signal having the enable value, coupling the signal input to the signal output; and
the first isolator circuit, in response to the isolator control signal having the disable value, disconnecting the signal input from the signal output and sets the signal output to zero volts.

14. The method of claim 4, wherein the states of operation of the controller circuit further include a diagnostic state in which a plurality of power switch circuits simultaneously enable a supply of power to a plurality of the data interface circuits.

15. The method of claim 4, wherein the states of operation of the controller circuit further include an off state in which none of the power switch circuits enable a supply of power to any of the data interface circuits.

16. The method of claim 4, further comprising the steps of:
providing within the controller circuit an interface ID logic circuit that stores an interface ID value that identifies which one of the interface activation states currently is selected by the interface ID logic circuit; and
the controller circuit reading the value stored in the interface ID logic circuit and then operating in the interface activation state identified by the interface ID logic circuit in response.

17. The method of claim 16, wherein the interface ID logic circuit comprises a pattern of open or closed circuits permanently established in the apparatus, wherein said pattern represents the interface ID value.

18. The method of claim 16, wherein the interface ID logic circuit comprises one or more flip-flops characterized by a state, and wherein the respective states of the flip-flops collectively represent the interface ID value.

19. The method of claim 16, further comprising the steps of:
providing within the interface ID logic circuit a register that stores the interface ID value; and
connecting a programmable processor to the register so that the programmable processor can read the interface ID value and cannot modify the interface ID value.

20. The method of claim 16, wherein:
providing within the interface ID logic circuit comprises a register that stores the interface ID value; and
connecting a programmable processor to the register so that the programmable processor can read and modify the interface ID value.

21. A method of separately powering a plurality of electrical circuits that are not used concurrently, comprising:
providing one or more power sources;
providing a number of separately powered electrical circuits, wherein the number is at least two;
providing a controller circuit characterized by a plurality of states of operation that include a plurality of activation states, wherein each respective activation state corresponds to a distinct respective one of the separately powered electrical circuits, and wherein the activation states are mutually exclusive so that the controller circuit cannot simultaneously operate in more than one of the activation states; and
providing a number of power switch circuits, wherein the number of power switch circuits is greater than or equal to the number of separately powered electrical circuits, and wherein each respective power switch circuit includes:
(i) a respective power input connected to one of the power sources,
(ii) a respective power output connected to exactly one of the separately powered electrical circuits, and
(iii) a respective power control input connected to receive a respective power control signal from the controller circuit;
each power switch circuit selectively enabling or disabling a supply of electrical power from its power input to its power output in response to whether the power control signal received at its power control input has an enable value or a disable value; and
the controller circuit, when operating in each respective activation state, sending a power control signal having said enable value to the power control input of each power switch circuit whose power output is connected to the separately powered electrical circuit corresponding to said activation state and sending a power control signal having said disable value to the power control input of each of the other power switch circuits.
